(19) United States
(12) Patent Application Publication
(10) Pub. No.: US 2025/0174871 A1
(43) Pub. Date: May 29, 2025

(54) WAVEGUIDE COUPLER WITH SELF-CONTAINED POLARIZATION ROTATION FOR INTEGRATED WAVEGUIDES, CIRCUITS, AND SYSTEMS

(71) Applicants: Huawei Technologies Canada Co., Ltd., Kanata (CA); la corporation de l' École Polytechnique de Montréal, Montreal (CA)

(72) Inventors: Ke Wu, Montreal (CA); Jie Deng, LeShan (CN)

(21) Appl. No.: 19/038,946

(22) Filed: Jan. 28, 2025

Related U.S. Application Data
(63) Continuation of application No. PCT/CA2022/051186, filed on Aug. 4, 2022.

(51) Int. Cl. H01P 5/18; H01P 1/165

(52) U.S. Cl. CPC H01P 5/182; H01P 1/165

(57) ABSTRACT

A waveguide coupler with integrated polarization is a module including one or more H-plane ports, two or more E-plane ports and a coupling element for transforming between H-plane port and E-plane ports. The coupling element including two or more coupling sections having a cavity and symmetrical about a symmetry plane. One or more of the symmetrical coupling sections having two or more grooves along a common side and at least one symmetrical coupling section having obstructions that may partially overlap with the two or more grooves. The grooves and obstructions are symmetrical about the symmetry plane. In an embodiment, the module is a four-port waveguide coupler having two H-plane port and two E-plane ports. In an embodiment, the ports are offset relative to the symmetry plan by forty-five degrees forming a cruciform waveguide coupler.

### CROSS-REFERENCE TO RELATED APPLICATION

This application is a continuation of PCT Application No. PCT/CA2022/051186, entitled “WAVEGUIDE COUPLER WITH SELF-CONTAINED POLARIZATION ROTATION FOR INTEGRATED WAVEGUIDES, CIRCUITS, AND SYSTEMS,” filed on Aug. 4, 2022, which application is hereby incorporated herein by reference in its entirety.

### TECHNICAL FIELD

The present disclosure relates generally to waveguide couplers, and in particular, to waveguide couplers having integrated polarization rotation.

### BACKGROUND

Waveguide couplers are commonly four-port components that are used in microwave, millimeter-wave, and terahertz circuits and systems for power detection, beamforming, power dividing, and power combining, as well being used in balanced amplifiers, sideband separating mixers, wireless communication systems, radar systems, and/or the like. Waveguide couplers commonly comprise two waveguide-channels side-by-side or layer-to-layer that are coupled to each other by different coupling structures. Waveguide couplers can generally be categorized into one of two types depending on their geometric configuration, namely E-plane and H-plane waveguide couplers. The electric-field polarization orientation of the E-plane couplers is orthogonal to that of the H-plane couplers. Due to their geometric features, E-plane and H-plane waveguide couplers can be used in different applications. In some integrated systems, separate modules and devices having different polarization orientation ports are assembled into a common structure. Whether a module or device is an E-plane or H-plane waveguide coupler, input and output ports have the same polarization orientation, with the result that they cannot be directly connected to ports having different polarization orientation directions, and waveguide twists are generally used to rotate the polarization orientation of electromagnetic waves propagating inside a waveguide coupler by a specified angle.

### SUMMARY

The present disclosure provides a waveguide coupler for integrated waveguides, circuits, and systems. The waveguide coupler comprise a compact coupling structure including one or more coupling sections for integrated polarization rotation thereby providing simplified interconnecting between E-plane and H-plane ports without the need of waveguide twists, giving rise to compact dimensions, reduced integration losses, and lowered complexity and cost of design, manufacture, and assembly.

In a broad aspect, the waveguide coupler may be a module or an apparatus for integrated waveguides, circuits, and systems. In the following, we describes using the module as an example for the waveguide coupler.

A module includes a first port, a second port, a third port and a coupling element, the first port for a first H-plane signal to propagate therethrough, the second port for a first E-plane signal to propagate therethrough, and the third port for a second E-plane signal to propagate therethrough. The coupling element is for transformation between the first H-plane signal and the first E-plane signal and for transformation between the first H-plane signal and the second E-plane signal, and defines or otherwise comprises a coupling cavity. The first port is located on a first side of the coupling cavity and the second port and the third port are located on a second side of the coupling cavity, the second side opposite the first side. A third side of the coupling cavity is adjacent the first and second sides as well as proximate to the first and second ports, the third side opposite a fourth side of the coupling cavity. A first axis extends perpendicularly between the first and second sides, a second axis extends parallel to the third and fourth sides, the second axis orthogonal to the first axis, and a third axis is orthogonal to the first and second axes. The second and third ports are opposite with respect to and symmetrical about a symmetry plane parallel to the first and second axes through a center of the coupling cavity. The coupling element includes a first coupling section comprising a first rectangular-prism cavity forming part of the coupling cavity. The first cavity includes the first side of the coupling cavity, and a first and a second side groove along the fourth side extending parallel to the first axis, the first and second side grooves being symmetrical about the symmetry plane. The second coupling section defines or otherwise comprises a second rectangular-prism cavity forming part of the coupling cavity. The second cavity includes the second side of the coupling cavity, and two obstructions on corners along the fourth side, the obstructions symmetrical about the symmetry plane.

In an embodiment, the module includes a fourth port located on the first side of the coupling cavity for a second H-plane signal to propagate through, wherein the first and fourth ports are opposite with respect to and symmetrical about the symmetry plane. When the first H-plane signal propagates through the first port towards the coupling cavity, the first E-plane signal and the second E-plane signals propagate away from the module, wherein a first phase of the first E-plane signal leads a second phase of the second E-plane signal by 90 degrees, and the fourth port is isolated from the first H-plane signal, the first E-plane signal and the second E-plane signal. When the first E-plane signal and the second E-plane signal propagate toward the coupling cavity, wherein the first phase leads the second phase by 90 degrees, the first H-plane signal propagates away from the module, and the fourth port is isolated from the first H-plane signal, the first E-plane signal and the second E-plane signal. When the second H-plane signal propagates through the fourth port towards the coupling cavity, the first E-plane signal and the second E-plane signals propagate away from the module, wherein the second phase leads the first phase by 90 degrees, and the first port is isolated from the second H-plane signal, the first E-plane signal and the second E-plane signal. When the first E-plane signal and the second E-plane signal propagate toward the coupling cavity, wherein the second phase leads the first phase by 90 degrees, the second H-plane signal propagates away from the module, and the first port is isolated from the second H-plane signal, the first E-plane signal and the second E-plane signal.

In an embodiment, each of the obstructions partially overlaps with one of the first and second side grooves.

In an embodiment, the first coupling section includes a first central groove along the fourth side extending parallel to the first axis and symmetrical about the symmetry plane.

In an embodiment, a first long edge of the first cavity forming part of the third side is greater than a second long edge of the second cavity forming part of the third side, and the first coupling section and the second coupling section are each symmetrical about the symmetry plane.

In an embodiment, the coupling element includes a third coupling section or otherwise comprising a third rectangular-prism cavity forming part of the coupling cavity, the third coupling section between the first and second coupling sections. The third coupling section including a third and a fourth side groove along the fourth side extending parallel to the first axis, the third and fourth side grooves being symmetrical about the symmetry plane, and a second central groove along the fourth side extending parallel to the first axis and symmetrical about the symmetry plane.

In an embodiment, a third long edge of the third cavity forming part of the third side is greater than the second long edge and less than the first long edge; and the third coupling section is symmetrical about the symmetry plane.

In an embodiment, for a center wavelength of a frequency range, the length of the first long edge is about 1.45 times the wavelength, a first short edge of the first coupling section parallel to the third edge, is about 0.32 times the wavelength, the first side groove is about 0.24 times the wavelength away from the first short edge, the first side groove extends about 0.14 times the wavelength away from the fourth side, the first side groove extends about 0.2 times the wavelength along the second axis, and the first coupling section has a depth of about 0.15 times the wavelength along the first axis.

In an embodiment, the obstructions are rectangular.

In an embodiment, the length of the second long edge is about 1.14 times the wavelength, a second short edge of the second coupling section parallel to the third edge, is about 0.62 times the wavelength, each obstruction extends about 0.24 times the wavelength along the second axis, each obstruction extends about 0.28 times the wavelength along the third axis, and the second coupling section has a depth of about 0.16 times the wavelength along the first axis.

In an embodiment, each of the obstructions includes a chamfered corner.

In an embodiment, the chamfered corner includes a double-step profile.

In an embodiment, the chamfered corner includes a multi-step profile.

In an embodiment, the chamfered corner includes a saw-tooth profile.

In an embodiment, the chamfered corner includes a smooth saw-tooth profile.

In an embodiment, for a center wavelength of a frequency range, the length of the third long edge is about 1.28 times the wavelength, a third short edge of the third coupling section parallel to the third edge, is about 0.35 times the wavelength, the third side groove is about 0.17 times the wavelength away from the third short edge, the third side groove extends about 0.1 times the wavelength away from the fourth side, the third side groove extends about 0.23 times the wavelength along the second axis, the second central groove extends about 0.62 times the wavelength away from the fourth side, the second central groove extends about 0.21 times the wavelength along the second axis, and the third coupling section has a depth of about 0.18 times the wavelength along the first axis.

In an embodiment, the first, second and third ports are angled at about 45 degrees relative to the symmetry plane.

In an embodiment, for a center wavelength of a frequency range, the length of the first long edge is about 1.42 times the wavelength, a first short edge of the first coupling section parallel to the third edge, is about 0.32 times the wavelength, the first side groove is about 0.22 times the wavelength away from the first short edge, the first side groove extends about 0.17 times the wavelength away from the fourth side, the first side groove extends about 0.26 times the wavelength along the second axis, and the first coupling section has a depth of about 0.17 times the wavelength along the first axis.

In an embodiment, the length of the second long edge is about 1.2 times the wavelength, a second short edge of the second coupling section parallel to the third edge, is about 0.62 times the wavelength, each obstruction includes a first-step adjacent the fourth side extending about 0.13 times the wavelength along the second axis and 0.15 times the wavelength along the third axis, and a second-step extending about 0.18 times the wavelength along the second axis and 0.12 times the wavelength along the third axis, and the second coupling section has a depth of about 0.16 times the wavelength along the first axis.

In an embodiment, for a center wavelength of a frequency range, the length of the third long edge is about 1.42 times the wavelength, a third short edge of the third coupling section parallel to the third edge, is about 0.32 times the wavelength, the third side groove extends about 0.16 times the wavelength away from the fourth side, the third side groove extends about 0.34 times the wavelength along the second axis, the second central groove extends about 0.26 times the wavelength away from the fourth side, the second central groove extends about 0.23 times the wavelength along the second axis, and the third coupling section has a depth of about 0.17 times the wavelength along the first axis.

### BRIEF DESCRIPTION OF THE DRAWINGS

For a more complete understanding of the disclosure, reference is made to the following description and accompanying drawings, in which:

FIG. 1A is a schematic of a prior art waveguide coupler having comprising waveguide twists;

FIG. 1B is a schematic of a waveguide coupler with integrated polarization rotation;

FIG. 2 is an isometric view of an embodiment of a waveguide coupler module comprising integrated polarization rotation;

FIG. 3A is an illustration of a first coupling section of the module of FIG. 2;

FIG. 3B is an illustration of a second coupling section of the module of FIG. 2;

FIG. 3C is an illustration of a third coupling section of the module of FIG. 2;

FIG. 4A is an illustration of an alternative embodiment of a third coupling section having obstructions with multi-step profiles;

FIG. 4B is an illustration of an alternative embodiment of a third coupling section having obstructions with chamfered corner profiles;

FIG. 4C is an illustration of an alternative embodiment of a third coupling section having obstructions with smooth saw-tooth profiles;

FIG. 4D is an illustration of an alternative embodiment of a third coupling section having obstructions with saw-tooth profiles;

FIG. 5A is an illustration showing e-field distribution through a third coupling section in TE₁₀ mode of an embodiment of a module;

FIG. 5B is an illustration showing e-field distribution through a third coupling section in TE₂₀ mode of an embodiment of a module;

FIG. 6A and FIG. 6B are illustrations showing a structure of a third coupling section of an embodiment of a module;

FIG. 7 is an illustration showing simulated e-field distribution results of an embodiment of a module;

FIG. 8 is a graph showing simulated reflection coefficient (S₁₁) and isolation (S₄₁) of an embodiment of a module;

FIG. 9 is a graph showing simulated transmission coefficient (S₂₁) and isolation (S₃₁) of an embodiment of a module;

FIG. 10 is a graph showing simulated phase imbalance of an embodiment of an embodiment of a module;

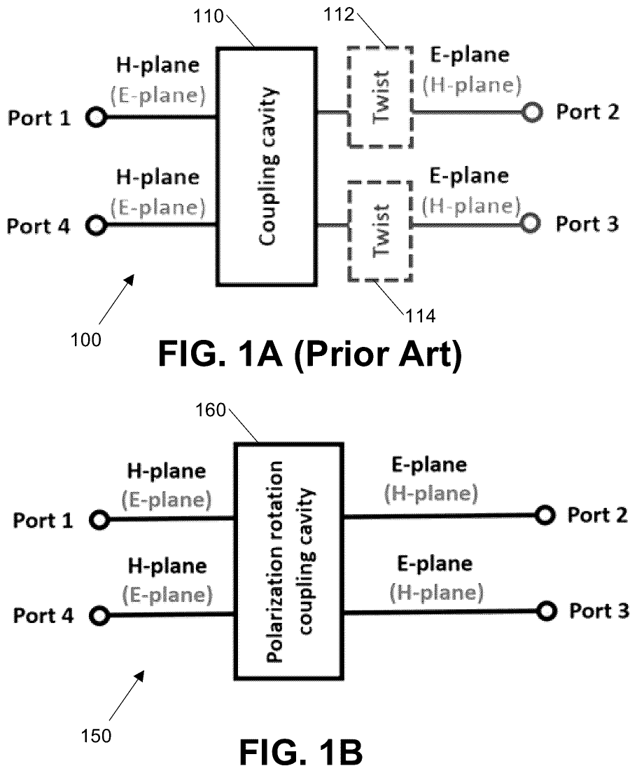

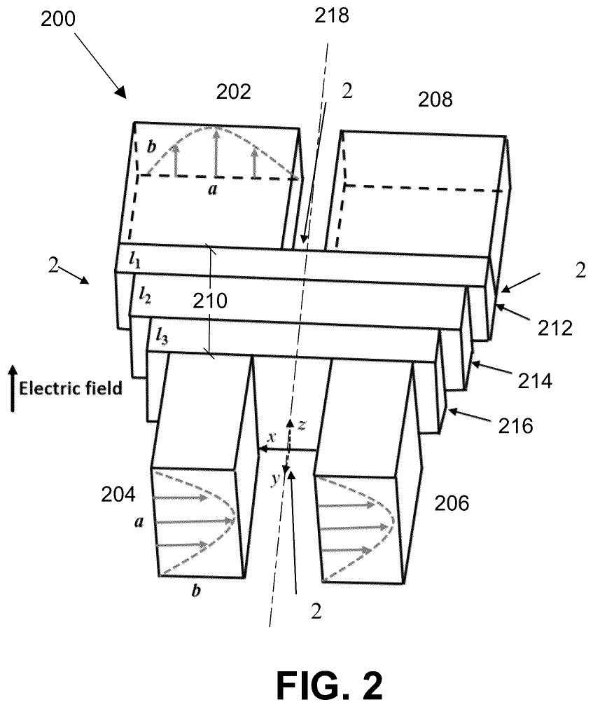

FIG. 1I is an isometric view of an embodiment of a cruciform waveguide coupler module comprising integrated polarization rotation;

FIG. 12A is an illustration of a first coupling section of the module of FIG. 11;

FIG. 12B is an illustration of a second coupling section of the module of FIG. 11;

FIG. 12C is an illustration of a third coupling section of the module of FIG. 11;

FIG. 13A is an illustration of an alternative embodiment of a third coupling section having obstructions with multi-step profiles;

FIG. 13B is an illustration of an alternative embodiment of a third coupling section having obstructions with chamfered corner profiles;

FIG. 13C is an illustration of an alternative embodiment of a third coupling section having obstructions with smooth saw-tooth profiles;

FIG. 13D is an illustration of an alternative embodiment of a third coupling section having obstructions with saw-tooth profiles;

FIG. 14 is an illustration showing simulated e-field distribution results of an embodiment of a module;

FIG. 15 is a graph showing simulated reflection coefficient (S₁₁) and isolation (S₄₁) of an embodiment of a module;

FIG. 16 is a graph showing simulated transmission coefficient (S₂₁) and isolation (S₃₁) of an embodiment of a module; and

FIG. 17 is a graph showing simulated phase imbalance of an embodiment of a module.

### DETAILED DESCRIPTION

Waveguide couplers are commonly four-port components that are used in microwave, millimeter-wave, and terahertz (THz) circuits and systems for power detection, beamforming, power dividing, and power combining, as well being used in balanced amplifiers, sideband separating mixers, wireless communication systems, radar systems, and/or the like. Waveguide couplers commonly comprise two waveguide-channels side-by-side or layer-to-layer that are coupled to each other by different coupling structures such as slots, holes, branches, and/or the like. Coupling levels, return losses, and isolation of couplers are generally determined by the specific coupling structures used.

Waveguide couplers can generally be categorized into one of two types depending on their geometric configuration, namely E-plane and H-plane waveguide couplers. The electric-field polarization orientation of the E-plane couplers is orthogonal to that of the H-plane couplers. Due to their geometric features, E-plane and H-plane waveguide couplers can be used in different applications. In some integrated systems, separate modules and devices having different polarization orientation ports are assembled into a common structure designed to fit within a specific volume. Whether a module or device is an E-plane or H-plane waveguide coupler, input and output ports have the same polarization orientation, with the result that they cannot be directly connected to ports having different polarization orientation directions. To rotate polarization orientations, separate waveguide twists are generally use to rotate the polarization orientation of electromagnetic waves propagating inside a waveguide coupler by a specified angle.

Many systems comprising waveguide couplers require 90-degree polarization rotation to integrate E-plane ports and H-plane ports. Referring to FIG. 1A, a prior-art waveguide coupler 100 comprises twists 112, 114 for polarization rotation, in addition to a coupling cavity 110. Smooth and multi-step waveguide twists are used to provide proper matching. Smooth and multi-step waveguide twists require a certain number of sections of several wavelengths to properly function, which results in an overall bulkier waveguide system. A compact waveguide twist having a single double-corner-cut square waveguide section may also be used. However, such compact waveguide twists are size-sensitive, having very tight tolerance requirements, making it difficult to apply in high-frequency ranges, especially at THz frequencies. As a result, such compact waveguide twists may have unpredictable performance. The introduction of additional waveguide twists 112, 114 not only increases the signal losses and size requirements but also increases the complexity of design, manufacturing, and assembly. This is particularly an issue in large-scale waveguide twist arrays. Referring to FIG. 1A, for example, an extra waveguide twist array 112, 114 is shown in the waveguide coupler 100 to realize polarization rotations.

In wireless communication network related applications, losses from additional twists leads to signal attenuation, with the result that signals may not be received and/or processed properly by a receiver. To reduce signal loss at a receiver, power may be increased in the transmitter. However, such an approach results in increased power consumption for both transmitting and receiving.

Referring to FIG. 1B, for many integrated applications, a waveguide coupler 150 comprising integrated polarization rotation with a coupling cavity 160, and not requiring additional waveguide twists, may be highly desirable.

Integrated applications of integrated waveguide circuits and systems comprise a combination of a plurality of discrete or separate modules, devices and subsystems. Generally, such integrated waveguide circuits and systems have limited or constrained space. As the discrete elements may comprise ports having different orientations, their layout and assembly within a common block having limited or constrained space present challenges. Waveguide couplers generally have ports with the same polarization orientation, and cannot be directly integrated into many waveguide systems. A coupler with integrated polarization rotation permits the coupler to be used in a waveguide system without the need of waveguide twists, thereby providing simplified interconnecting between E-plane and H-plane ports, and thus giving rise to compact dimensions, reduced integration losses, and lowered complexity and cost of design, manufacture, and assembly.

Embodiments of a module disclosed herein provide a waveguide coupler with integrated polarization orientation rotation of electromagnetic waves propagating inside waveguide-channels by a specified angle such as 90 degrees. With alternative solutions, additional waveguide twists must be connected outside a waveguide coupler to achieve required polarization rotation. In the present disclosure, polarization rotation occurs completely in an inner coupling cavity of a waveguide coupler. An ultra-compact structure is provided, and its length is only 0.5*λ, in which λ is the free-space wavelength at the operating frequency.

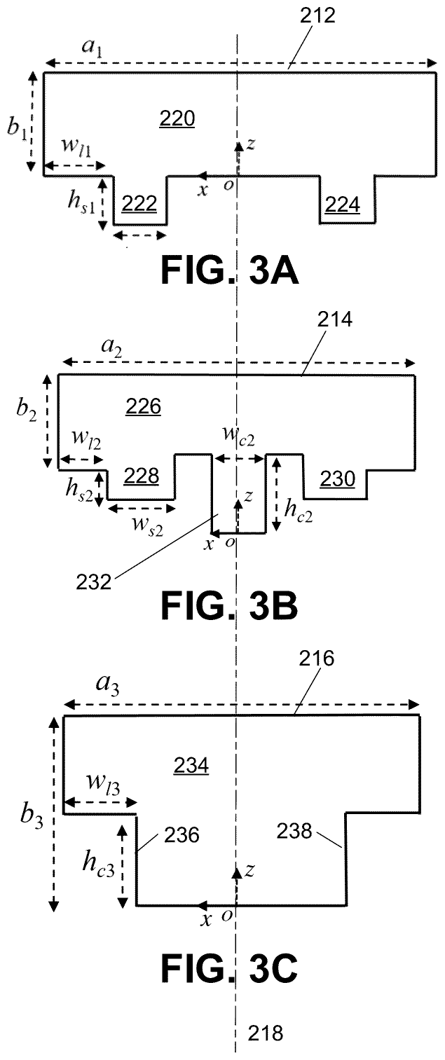

Referring to FIG. 2, an embodiment of a module 200 is shown. For ease of description, a first axis is shown as the y-axis, a second axis is shown as the z-axis, and a third axis is shown as the x-axis. The module 200 comprises a waveguide coupler with integrated polarization rotation comprises a first port 202, a second port 204, a third port 206 and a coupling element 210 defining or otherwise comprising a coupling cavity, wherein the first port 202 is connected to a first side 203 of the coupling cavity and the second port 204 and the third port 206 are connected to a second side 205 of the coupling cavity, the second side 205 opposing the first side 203 and are adjacent opposite third side 207 and fourth side 209. In embodiments disclosed herein, the module 200 further comprises a fourth port 208 connected to the first side. In embodiments disclosed herein, the first port 202 and the fourth port 208 are for H-plane signals to propagate therethrough and the second port 204 and the third port 206 are for E-plane signals to propagate therethrough. The coupling element 210 is for transforming between H-plane signals of the first port 202 and the fourth port 208 and E-plane signals of the second port 204 and the third port 206. In embodiments disclosed herein, the module 200 comprises a symmetry plane 218 parallel to a first axis (that is, the y-axis) and a second axis (that is, the z-axis) through a center of the coupling cavity. The first port 202 is symmetrical with the fourth port 208 about the symmetry plane 218. The second port 204 is symmetrical with the third port 206 about the symmetry plane 218.

In embodiments disclosed herein, the coupling element 210 comprises one or more coupling sections. In an embodiment disclosed herein, the coupling element 210 comprises a first coupling section 212 connected to the first port 202 and the fourth port 208, and a third coupling section 216 connected to the second port 204 and the third port 206, and, optionally, a second coupling section 214 between the first coupling section 212 and the third coupling section 216. In an embodiment disclosed herein, the coupling element 210 comprises a second coupling section 214 connected to the first port 202 and the fourth port 208, and a third coupling section 216 connected to the second port 204 and the third port 206, and, optionally, a first coupling section 212 between the second coupling section 214 and the third coupling section 216.

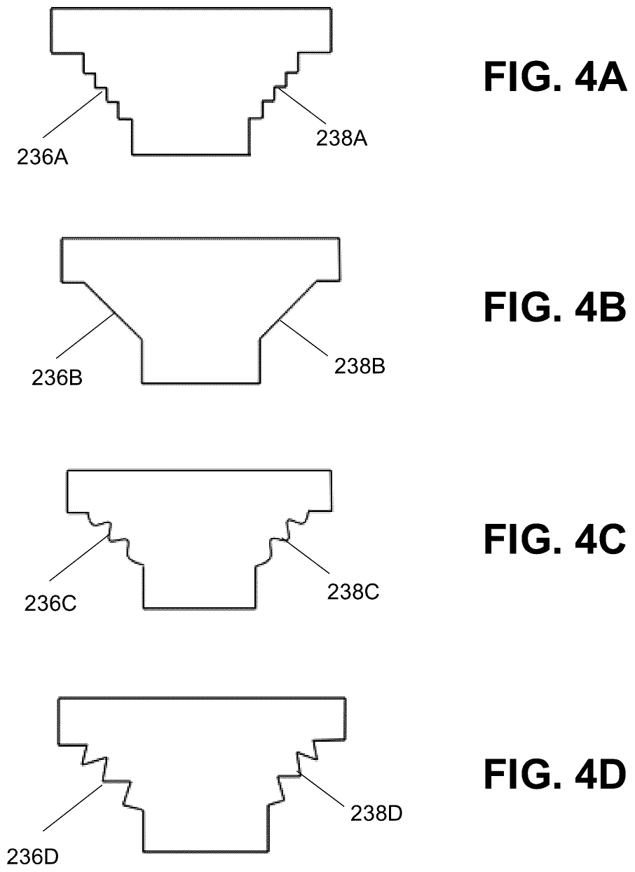

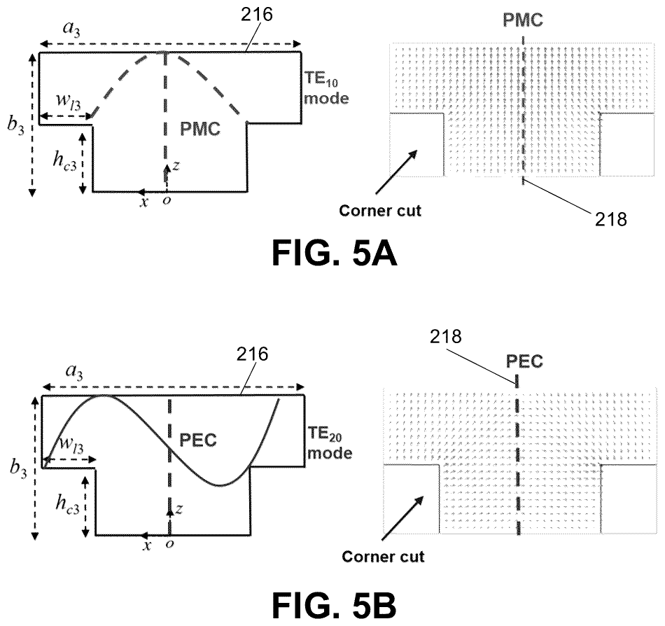

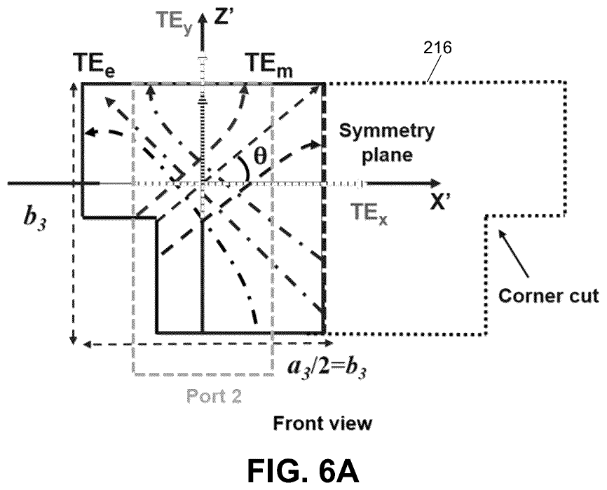

Referring to FIG. 3A, in an embodiment disclosed herein, the first coupling section 212 defines or otherwise comprises a first rectangular-prism cavity 220 forming part of the coupling cavity. The first cavity 220 comprises a first side groove 222 and a second side groove 224 along a common side of the coupling cavity extending along the x-axis. In embodiments disclosed herein, the first side groove 222 and the second side groove 224 are symmetrical about the symmetry plane 218.

Referring to FIG. 3B, in an embodiment disclosed herein, the second coupling section 214 defines or otherwise comprises a second rectangular-prism cavity 226 forming part of the coupling cavity. The second cavity 226 comprises a third side groove 228 and a fourth side groove 230 along the common side. In embodiments disclosed herein, the third side groove 228 and the fourth side groove 230 are symmetrical about the symmetry plane 218. The second cavity 226 further comprises a central groove 232 symmetrical about the symmetry plane 218.

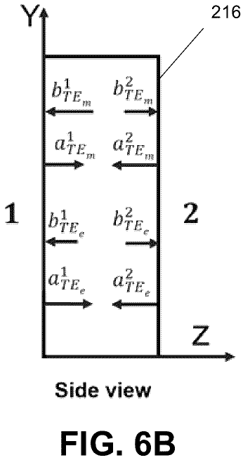

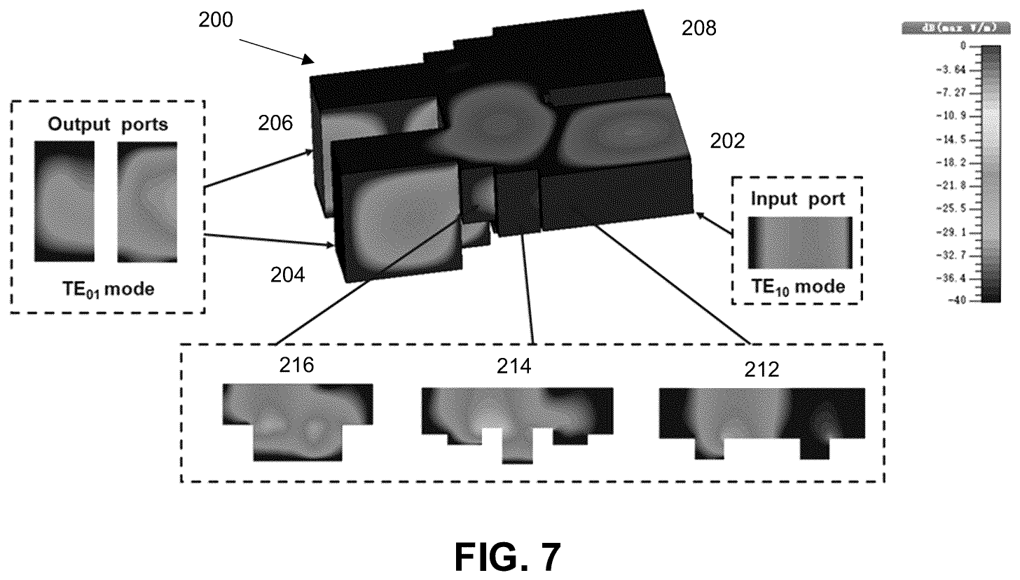

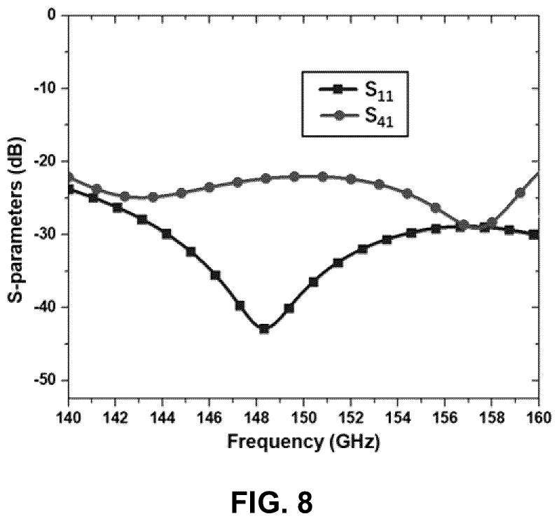

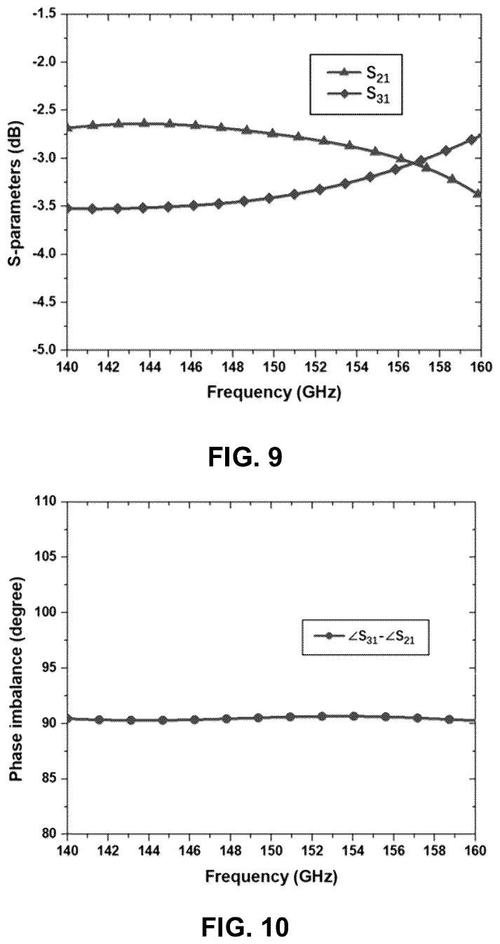

Referring to FIG. 3C, in an embodiment disclosed herein, the third coupling section 216 defines or otherwise comprises a third rectangular-prism cavity 234 forming part of the coupling cavity. The third cavity 234 comprises a first obstruction 236 and a second obstruction 238 at corners of the common side. In embodiments disclosed herein, the first obstruction 236 and the second obstruction 238 are symmetrical about the symmetry plane 218. In embodiments disclosed herein, the first obstruction 236 partially overlaps with the first side groove 222 and/or the third side groove 228, and the second obstruction 238 partially overlaps with the second side groove 224 and/or the fourth side groove 230. In embodiments disclosed herein, the first obstruction 236 and the second obstruction 238 have a rectangular profile as illustrated in FIG. 3C, have a double-step profile 1136, 1138 as illustrated in FIG. 12C, have a multi-step profile 236A, 238A as illustrated in FIG. 4A, have a chamfered corner profile 236B, 238B as illustrated in FIG. 4B, have a smooth saw-tooth profile 236C, 238C as illustrated in FIG. 4C or have a saw-tooth profile 236D, 238D as illustrated in FIG. 4D.

In embodiments disclosed herein, the module 200 is dimensioned for a particular operating frequency range having an operating center frequency (f), wherein λ is the wavelength associated with f. Referring to FIG. 3A, the first coupling section 212 is dimensioned as follows: a₁=1.45*λ, b₁=0.32*λ, wₗ₁=0.24*λ, hₛ₁=0.14*λ, and wₛ₁=0.2*λ. Referring to FIG. 3B, the second coupling section 214 is dimensioned as follows: a₂=1.28*λ, b₂=0.35*λ, wₗ₂=0.17*λ, hₛ₂=0.1*λ, wₛ₂=0.23*λ, w_{c2}=0.21*λ, and h_{c2}=0.62*λ. Referring to FIG. 3C, the third coupling section 216 is dimensioned as follows: a₃=1.14*λ, b₃=0.62*λ, h_{c3}=0.28*λ, and wₗ₃=0.24*λ. Referring to FIG. 2, l₁=0.15*λ, l₂=0.18*λ, and l₃=0.16*λ.

In an embodiment, the module 200 is dimensioned for an operating frequency range between about 140-160 GHz with a center frequency of 150 GHz. Referring to FIG. 3A, the first coupling section 212 is dimensioned as follows: a₁=2.91 mm, b₁=0.65 mm, wₗ₁=0.48 mm, hₛ₁=0.28 mm, and wₛ₁=0.41 mm. Referring to FIG. 3B, the second coupling section 214 is dimensioned as follows: a₂=2.57 mm, b₂=0.65 mm, wₗ₂=0.34 mm, hₛ₂=0.21 mm, wₛ₂=0.47 mm, w_{c2}=0.43 mm, and h_{c2}=1.24 mm. Referring to FIG. 3C, the third coupling section 216 is dimensioned as follows: a₃=2.28 mm, b₃=1.24 mm, h_{c3}=0.57 mm, wₗ₃=0.48 mm. Referring to FIG. 2, l₁=0.31 mm, l₂=0.37 mm, and l₃=0.32 mm.

Specific dimensions and dimensions relative to λ provided herein are example embodiments and are not intended to be limiting. Specifically, the module 200 described herein operates where dimensions are outside the specific and relative dimensions provided herein.

In embodiments disclosed herein, the module 200 is a directional coupler that divides an electromagnetic signal from an open end of the coupler into two open ends of the coupler, for example, from the first port 202 to the second port 204 and the third port 206, while maintaining the fourth port 208 isolated or combines two electromagnetic signals from two open ends of the coupler to another open end of the coupler, for example, from the second port 204 and the third port 206 to the fourth port 208 while maintaining the first port 202 isolated. In embodiments disclosed herein, the coupling element 210 comprises three coupling sections series-arranged along the symmetry plane 218, two horizontally positioned H-plane ports (the first port 202 and the fourth port 208), and two vertically positioned E-plane ports (the second port 204 and the third port 206). The H-plane ports support a TE₁₀ mode and the E-plane ports support a TE₀₁ mode. The electric-field component of TE₁₀ mode is orthogonal with that of TE₀₁ mode. Referring to FIG. 2, in embodiments disclosed herein, for the WR-5.1 band, both H-plane and E-plane ports are standard waveguides (a=1.295 mm, b=0.647 mm).

In summary, in operation of an embodiment disclosed herein, when, a first H-plane signal propagates through the first port 202 towards the coupling cavity, a first E-plane signal propagates away from the module 200 through the second port 204 and a second E-plane signals propagates away from the module 200 through the third port 206, wherein a first phase of the first E-plane signal leads a second phase of the second E-plane signal by 90 degrees, and the fourth port 208 is isolated from the first H-plane signal, the first E-plane signal and the second E-plane signal. When the first E-plane signal and the second E-plane signal propagate toward the coupling cavity, wherein the first phase leads the second phase by 90 degrees, the first H-plane signal propagates away from the module 200, and the fourth port 208 is isolated from the first H-plane signal, the first E-plane signal and the second E-plane signal. When the second H-plane signal propagates through the fourth port 208 towards the coupling cavity, the first E-plane signal and the second E-plane signals propagate away from the module 200, wherein the second phase leads the first phase by 90 degrees, and the first port 202 is isolated from the second H-plane signal, the first E-plane signal and the second E-plane signal. When the first E-plane signal and the second E-plane signal propagate toward the coupling cavity, wherein the second phase leads the first phase by 90 degrees, the second H-plane signal propagates away from the module 200, and the first port 202 is isolated from the second H-plane signal, the first E-plane signal and the second E-plane signal.

In embodiments disclosed herein, to achieve broadband matching, the first coupling section 212, the second coupling section 214, and the third coupling section 216 form a stepped impedance transformer. Specifically, referring to FIG. 3A to FIG. 3C, in embodiments disclosed herein, where the widths (a₁, a₂, a₃) of the coupling sections form a multiple-step structure. As the height of the third coupling section 216, b₃, is almost twice the height of the first coupling section 212, b₁, and the second coupling section 214, b₂, a pair of symmetrically located grooves, comprising the first groove 222 and the second groove 224, with height (hₛ₁) and width (wₛ₁) are included in the first coupling section 212. The second coupling section 214 comprises the third side groove 228, the fourth side groove 230 and the central groove 232, the third and fourth side grooves having a height, hₛ₂, and width, wₛ₂, and the central groove having a height, h_{c2}, and width, w_{c2}. The side grooves and central grove in the first and second coupling sections 212, 214 guide the electromagnetic signals to the third coupling section 216.

The H-plane ports (the first port 202 and the fourth port 208) and the first and second coupling sections 212, 214 can be considered as one-half of a Riblet coupler. According to odd-even mode analysis, when the first port 202 excites TE₁₀ mode, both even-TE₁₀ and odd-TE₂₀ modes can be excited in the first and second coupling sections 212, 214. Higher-order modes, for example, TE₃₀ mode, can be suppressed by controlling the width of the first and second coupling sections 212, 214. Meanwhile, TE₁₀ and TE₂₀ modes can be manipulated to obtain a cancellation of signals at the isolation port (the fourth port) as well as a superposition of signals in the third coupling section 216.

To provide the desired polarization rotation, in embodiments disclosed herein, the third coupling section 216 comprises two symmetrical obstructions on corners along the common side, each having a width, wₗ₃, and a height, h_{c3}. This rotates the vertical E-field components along the z-axis and generates the horizontal E-field components along the x-axis. Horizontal E-field components will excite the TE₀₁ mode at the E-plane ports (the second port 204 and the third port 206). Therefore, a polarization rotation is provided by choosing appropriate values of a width, wₗ₃, and a height, h_{c3}.

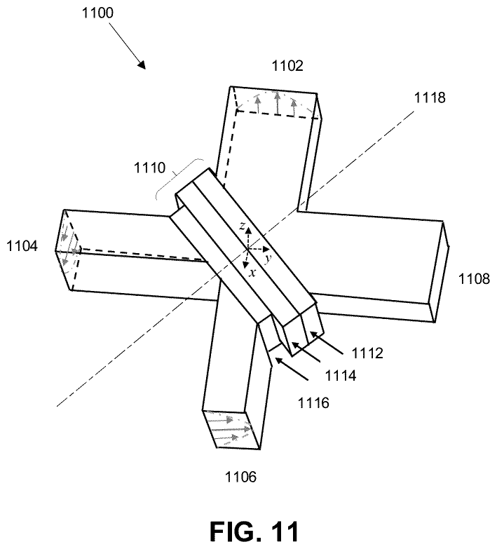

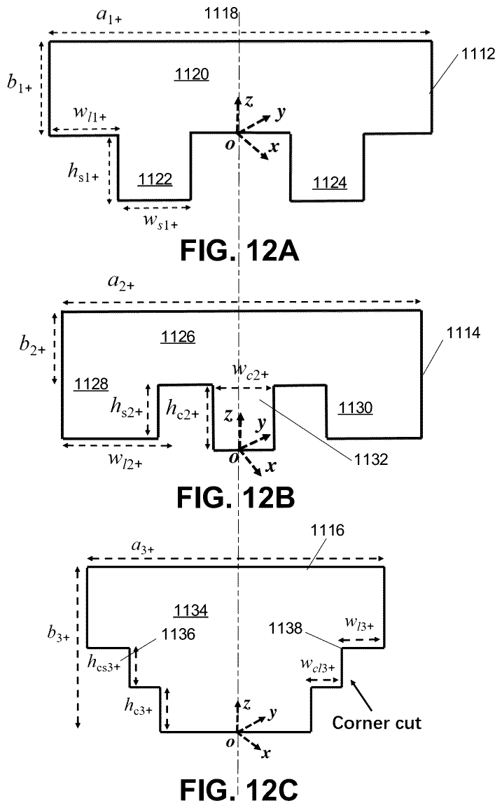

To further explain the mechanism of polarization, the third coupling section 216 is analyzed in additional detail. The first two modes of the third coupling section 216 are TE₁₀ mode and TE₂₀ mode, respectively, as illustrated in FIG. 5A and FIG. 5B. For a TE₁₀ mode, the symmetry plane 218 can act as the perfect magnetic conductor (PMC), where the electric vector is parallel with the x-z plane. Similarly, for the TE₂₀ mode, the symmetry plane 218 can act as the perfect electric conductor (PEC), where the electric vector is vertical with the x-z plane. A half structure of the third coupling section 216 is considered for the sake of simplicity. As the width, a₃, is about twice the height, b₃, a half structure of the third coupling section 216 is a square waveguide. According to the dual-mode coupling principle, a square waveguide with a corner cut will produce two polarization field components with the inclination angle θ, which are called TEₑ mode and TEₘ mode, respectively, which are orthogonal.

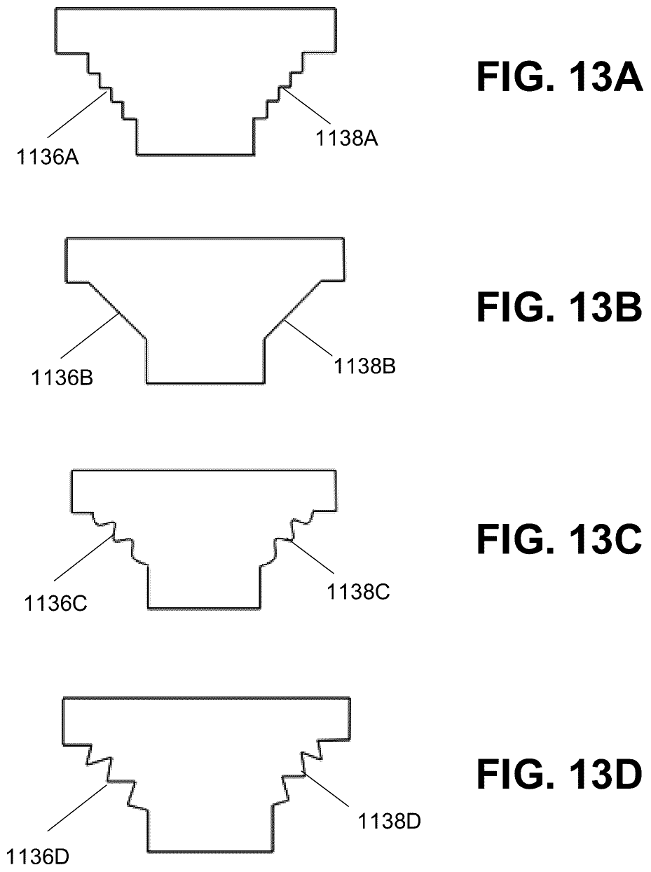

Referring to FIG. 6A and FIG. 5B, due to the introduction of the corner cut, the slanted electric-field components of the TE₁₀ mode and TE₂₀ mode are generated, which contributes to the TEₑ and TEₘ components. The TEₑ and TEₘ on both sides of the third coupling section 216 can be described by the following scattering matrices:

$$\{ \begin{matrix}{b}_{T {E}_{m}}^{1} \\ {b}_{T {E}_{m}}^{2}\end{matrix} \} = [ \begin{matrix}{S}_{11} & {S}_{12} \\ {S}_{21} & {S}_{22}\end{matrix} ] \{ \begin{matrix}{a}_{T {E}_{m}}^{1} \\ {a}_{T {E}_{m}}^{2}\end{matrix} \} \qquad ( 1 )$$

$$and$$

$$\{ \begin{matrix}{b}_{{TE}_{e}}^{1} \\ {b}_{{TE}_{e}}^{2}\end{matrix} \} = [ \begin{matrix}{S}_{11} & {S}_{12} \\ {S}_{21} & {S}_{22}\end{matrix} ] \{ \begin{matrix}{a}_{{TE}_{e}}^{1} \\ {a}_{{TE}_{e}}^{2}\end{matrix} \} \qquad ( 2 )$$

where {b_{TE}_{ₘ}¹, b_{TE}_{ₘ}²} and {a_{TE}_{ₘ}¹, a_{TE}_{ₘ}²} are the magnitudes of incident and reflected waves of the TEₘ field component and {b_{TE}_{ₑ}¹, b_{TE}_{ₑ}²} and {a_{TE}_{ₑ}¹, a_{TE}_{ₑ}²} are the magnitudes of incident and reflected waves of the TEₑ field component. The third coupling section 216 is a reciprocal structure.

Therefore,

$${S}_{11} = {S}_{22} = {S}^{11} and {S}_{12} = {S}_{21} = {S}^{21} \qquad ( 3 )$$

So, substituting (3) into (1) and (2) gives

$$\{ \begin{matrix}{b}_{T {E}_{m}}^{1} \\ {b}_{T {E}_{m}}^{2}\end{matrix} \} = [ \begin{matrix}{S}_{T {E}_{m}}^{11} & {S}_{T {E}_{m}}^{21} \\ {S}_{T {E}_{m}}^{21} & {S}_{T {E}_{m}}^{11}\end{matrix} ] \{ \begin{matrix}{a}_{T {E}_{m}}^{1} \\ {a}_{T {E}_{m}}^{2}\end{matrix} \} \qquad ( 4 )$$

$$\{ \begin{matrix}{b}_{{TE}_{e}}^{1} \\ {b}_{{TE}_{e}}^{2}\end{matrix} \} = [ \begin{matrix}{S}_{{TE}_{e}}^{11} & {S}_{{TE}_{e}}^{21} \\ {S}_{{TE}_{e}}^{21} & {S}_{{TE}_{e}}^{11}\end{matrix} ] \{ \begin{matrix}{a}_{{TE}_{e}}^{1} \\ {a}_{{TE}_{e}}^{2}\end{matrix} \} \qquad ( 5 )$$

TE_{H} and TE_{V} are defined as the horizontal and vertical components of the electric field, respectively, with TE_{H} being parallel to the x′-axis (as illustrated in FIG. 6A) and TE_{V} being parallel to the y′-axis (as illustrated in FIG. 6A). Considering the projection relations of TEₘ and TEₑ field components and TE_{H} and TE_{V}, the following equations can be obtained:

$$\{ \begin{matrix}{a}_{T {E}_{m}}^{1} = {a}_{T {E}_{H}}^{1} cos θ + {a}_{T {E}_{V}}^{1} sin θ \\ {b}_{T {E}_{m}}^{1} = {b}_{T {E}_{H}}^{1} cos θ + {b}_{T {E}_{V}}^{1} sin θ \\ {a}_{T {E}_{m}}^{2} = {a}_{T {E}_{H}}^{2} cos θ + {a}_{T {E}_{V}}^{2} sin θ \\ {b}_{T {E}_{m}}^{2} = {b}_{T {E}_{H}}^{2} cos θ + {b}_{T {E}_{V}}^{2} sin θ\end{matrix} \qquad ( 6 )$$

$$\{ \begin{matrix}{a}_{T {E}_{e}}^{1} = - {a}_{T {E}_{H}}^{1} sin θ + {a}_{T {E}_{V}}^{1} cos θ \\ {b}_{T {E}_{e}}^{1} = - {b}_{T {E}_{H}}^{1} sin θ + {b}_{T {E}_{V}}^{1} cos θ \\ {a}_{T {E}_{e}}^{2} = - {a}_{T {E}_{H}}^{2} sin θ + {a}_{T {E}_{V}}^{2} cos θ \\ {b}_{T {E}_{e}}^{2} = - {b}_{T {E}_{H}}^{2} sin θ + {b}_{T {E}_{V}}^{2} cos θ\end{matrix} \qquad ( 7 )$$

Substituting (6) and (7) into (4) and (5), respectively, gives

$$\{ \begin{matrix}{b}_{T {E}_{H}}^{1} cos θ + {b}_{{TE}_{V}}^{1} sin θ \\ {b}_{T {E}_{H}}^{2} cos θ + {b}_{{TE}_{V}}^{2} sin θ\end{matrix} \} = [ \begin{matrix}{S}_{T {E}_{m}}^{11} & {S}_{T {E}_{m}}^{21} \\ {S}_{T {E}_{m}}^{21} & {S}_{T {E}_{m}}^{11}\end{matrix} ] \{ \begin{matrix}{a}_{T {E}_{H}}^{1} cos θ + {a}_{{TE}_{V}}^{1} sin θ \\ {a}_{T {E}_{H}}^{2} cos θ + {a}_{{TE}_{V}}^{2} sin θ\end{matrix} \} \qquad ( 8 )$$

$$\{ \begin{matrix}- {b}_{T {E}_{H}}^{1} sin θ + {b}_{{TE}_{V}}^{1} cos θ \\ - {b}_{T {E}_{H}}^{2} sin θ + {b}_{{TE}_{V}}^{2} cos θ\end{matrix} \} = [ \begin{matrix}{S}_{T {E}_{e}}^{11} & {S}_{T {E}_{e}}^{21} \\ {S}_{T {E}_{e}}^{21} & {S}_{T {E}_{e}}^{11}\end{matrix} ] \{ \begin{matrix}- {a}_{T {E}_{H}}^{1} sin θ + {a}_{{TE}_{V}}^{1} cos θ \\ - {a}_{T {E}_{H}}^{2} sin θ + {a}_{{TE}_{V}}^{2} cos θ\end{matrix} \} \qquad ( 9 )$$

Combining (8) and (9) obtains

$$\{ \begin{matrix}{b}_{T {E}_{H}}^{1} \\ {b}_{T {E}_{V}}^{1} \\ {b}_{T {E}_{H}}^{2} \\ {b}_{T {E}_{V}}^{2}\end{matrix} \} = [ \begin{matrix}cos θ & 0 & - sin θ & 0 \\ sin θ & 0 & cos θ & 0 \\ 0 & cos θ & 0 & - sin θ \\ 0 & sin θ & 0 & cos θ\end{matrix} ] [ \begin{matrix}{S}_{T {E}_{m}}^{11} & {S}_{T {E}_{m}}^{21} & 0 & 0 \\ {S}_{T {E}_{m}}^{21} & {S}_{T {E}_{m}}^{11} & 0 & 0 \\ 0 & 0 & {S}_{T {E}_{e}}^{11} & {S}_{T {E}_{e}}^{21} \\ 0 & 0 & {S}_{T {E}_{e}}^{21} & {S}_{T {E}_{e}}^{11}\end{matrix} ] [ \begin{matrix}cos θ & sin θ & 0 & 0 \\ 0 & 0 & cos θ & cos θ \\ - sin θ & cos θ & 0 & 0 \\ 0 & 0 & sin θ & cos θ\end{matrix} ] \{ \begin{matrix}{a}_{T {E}_{H}}^{1} \\ {a}_{T {E}_{V}}^{1} \\ {a}_{T {E}_{H}}^{2} \\ {a}_{T {E}_{V}}^{2}\end{matrix} \} \qquad ( 10 )$$

Expand (10), then the following matrix can be obtained:

$$\{ \begin{matrix}{b}_{T {E}_{H}}^{1} \\ {b}_{T {E}_{V}}^{1} \\ {b}_{T {E}_{H}}^{2} \\ {b}_{T {E}_{V}}^{2}\end{matrix} \} = [ \begin{matrix}\frac{1}{2} [ S \text{?} + S \text{?} + ( S \text{?} - S \text{?} ) \sqrt{1 - {sin ( 2 θ )}^{2}} ] & \frac{1}{2} sin ( 2 θ ) ( S \text{?} - S \text{?} ) & \\ \frac{1}{2} sin ( 2 θ ) ( S \text{?} - S \text{?} ) & \frac{1}{2} [ S \text{?} + S \text{?} + ( S \text{?} - S \text{?} ) \sqrt{1 - {sin ( 2 θ )}^{2}} ] & \\ \frac{1}{2} [ S \text{?} + S \text{?} + ( S \text{?} - S \text{?} ) \sqrt{1 - {sin ( 2 θ )}^{2}} ] & \frac{1}{2} sin ( 2 θ ) ( S \text{?} - S \text{?} ) & … \\ \frac{1}{2} sin ( 2 θ ) ( S \text{?} - S \text{?} ) & \frac{1}{2} [ S \text{?} + S \text{?} + ( S \text{?} - S \text{?} ) \sqrt{1 - {sin ( 2 θ )}^{2}} ] & \end{matrix} \qquad ( 11 )$$

$$\begin{matrix} & \frac{1}{2} [ S \text{?} + S \text{?} + ( S \text{?} - S \text{?} ) \sqrt{1 - {sin ( 2 θ )}^{2}} ] & \frac{1}{2} sin ( 2 θ ) ( S \text{?} - S \text{?} ) \\ & \frac{1}{2} sin ( 2 θ ) ( S \text{?} - S \text{?} ) & \frac{1}{2} [ S \text{?} + S \text{?} + ( S \text{?} - S \text{?} ) \sqrt{1 - {sin ( 2 θ )}^{2}} ] \\ … & \frac{1}{2} [ S \text{?} + S \text{?} + ( S \text{?} - S \text{?} ) \sqrt{1 - {sin ( 2 θ )}^{2}} ] & \frac{1}{2} sin ( 2 θ ) ( S \text{?} - S \text{?} ) \\ & \frac{1}{2} sin ( 2 θ ) ( S \text{?} - S \text{?} ) & \frac{1}{2} [ S \text{?} + S \text{?} + ( S \text{?} - S \text{?} ) \sqrt{1 - {sin ( 2 θ )}^{2}} ]\end{matrix} ] * \{ \begin{matrix}{a}_{T {E}_{H}}^{1} \\ {a}_{T {E}_{V}}^{1} \\ {a}_{T {E}_{H}}^{2} \\ {a}_{T {E}_{V}}^{2}\end{matrix} \}$$

$$\text{?} \text{indicates text missing or illegible when filed}$$

From (11), the following coupling mechanism can be observed:
a) When θ=0° or θ=90°, there is no coupling between the TE_{V} mode and TE_{H} mode.
b) The variation of the coupling versus, the θ value is a function of sin(20). Therefore, the maximum coupling occurs at θ=45°.
c) The coupling between the TE_{V} mode and TE_{H} mode is proportional to the differences of S_{TEm}¹¹ and S_{TEe}¹¹ or S_{TEm}²¹ and S_{TEe}²¹. If there is no corner cut, S_{TEm}¹¹=S_{TEe}¹¹ and S_{TEm}²¹=S_{TEe}²¹ there is no coupling between the TE_{V} mode and TE_{H} mode.

As above, TE_{H} is parallel to the x′-axis (as illustrated in FIG. 6A) and TE_{V} is parallel to the y′-axis (as illustrated in FIG. 6A). TE_{V} can excite the TE₁₀ mode and TE_{H} can excite the TE₀₁ mode. Alternatively, TE₁₀ can excite the TE_{V} mode and TE₀₁ can excite the TE_{H} mode. The TE₁₀ mode and TE₂₀ mode in the third coupling section 216 generates slanted TEₘ and TEₑ field components, which in turn generates TE_{H}. Thereby, the generated TE_{H} generates TE₀₁ at a H-plane port. Therefore, the third coupling section 216 provides the polarization rotation.

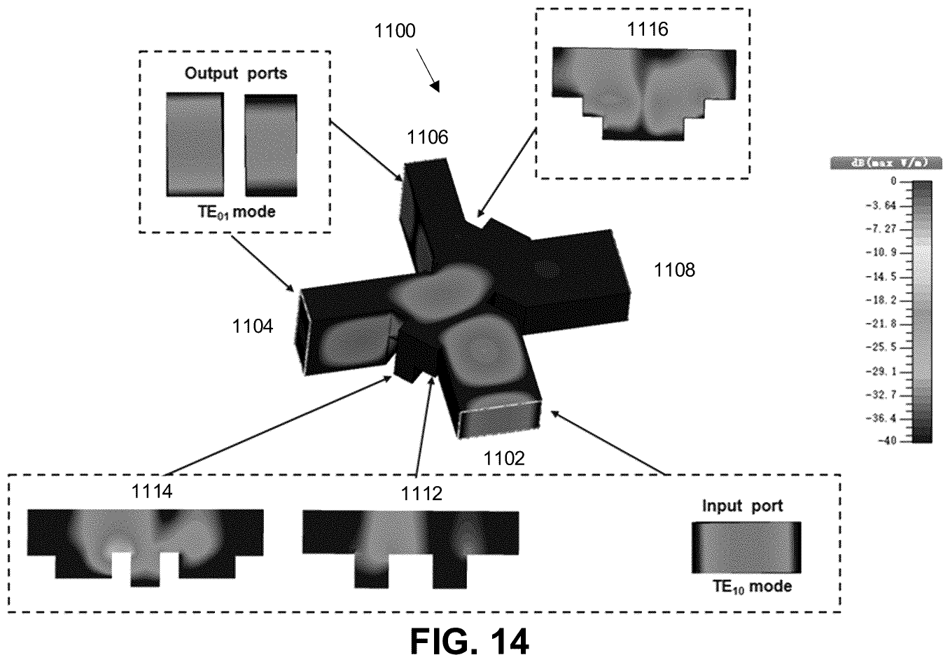

Computer simulation technology can be used to simulate the waveguide coupler. An example embodiment of the module 200 is simulated for E-field distributions as shown in FIG. 7. FIG. 7 shows an excited TE₁₀ mode at the horizontally positioned H-plane port (the first port 202) successfully converted to a TE₀₁ mode at the two vertically positioned E-plane ports (the second port 204 and the third port 206) through the coupling cavity with approximately equal magnitudes. Of note, there is no wave at the isolated port (the fourth port 208).

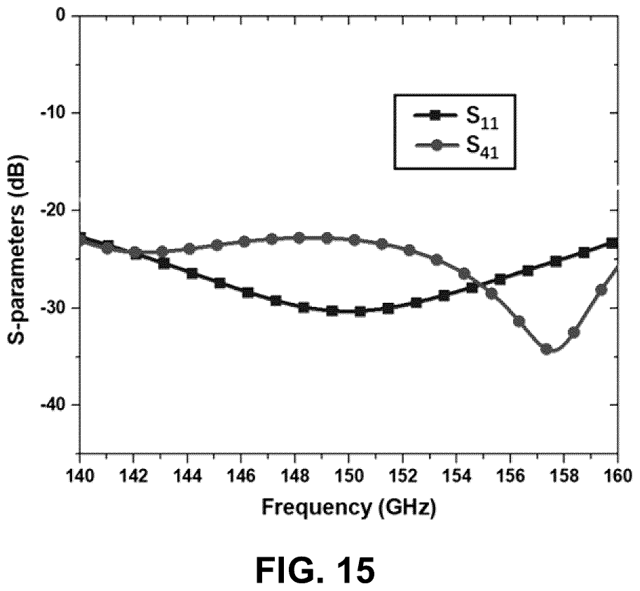

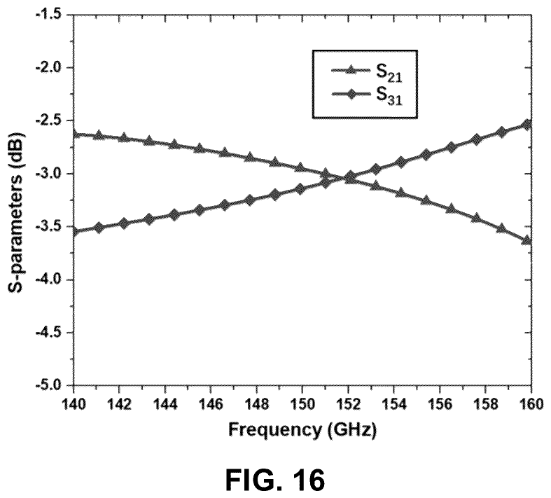

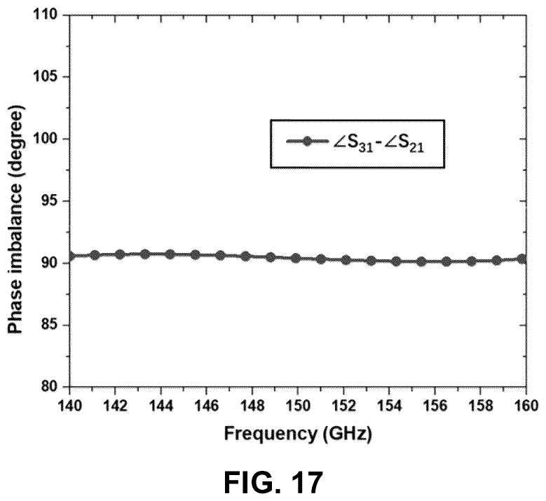

FIG. 8 to FIG. 10 illustrate simulated results of an embodiment of a module 200, wherein it can be observed that over a frequency range of interest from 140 GHz to 160 GHz, both S₂₁ and S₃₁ vary from 3±0.5 dB with an isolation between the two output ports greater than 20 dB, and the input port reflection coefficient is better than −20 dB. The phase difference between the two output ports (the second port 204 and the third port 206) is 90 degrees. Further, it is notable that the entire length of the coupler is only 0.5*λ, where λ is a wavelength corresponding to the center frequency. Specifically, FIG. 8 illustrates simulated reflection coefficient (S₁₁) and isolation (S₄₁) of the module 200, FIG. 9 illustrates simulated transmission coefficient (S₂₁) and isolation (S₃₁) of the module 200, and FIG. 10 illustrates simulated phase imbalance of the module 200.

In embodiments disclosed herein, the modules 200 are air-filled hollow waveguide components and in other embodiment disclosed herein, they are filled with a dielectric material. In embodiments disclosed herein, modules 200 are fabricated with conventional computer numerical control (CNC) machining, electrical discharge machining (EDM) process or 3D printing.

Embodiments disclosed herein, provide a module 200 for a waveguide coupler with integrated polarization orientation rotation of electromagnetic waves propagating therein that is extremely compact with a low-loss structure, providing a simple design for connection of E-plane and H-plane waveguide components, and comprising self-contained polarization rotation without additional waveguide twist. The module 200 can be compatible with required characteristics of H-plane waveguide technologies and E-plane waveguide technologies and allows development of new waveguide circuits and systems.

Referring to FIG. 11, in an embodiment disclosed herein, a module 1100 is a cruciform variation of the module 200, wherein the first port 1102, the second port 1104, the third port 1106 and the fourth port 1108 are angled at about 45 degrees relative to the symmetry plane 1118.

An embodiment of the module 1100 comprising a cruciform waveguide coupler with integrated polarization rotation comprises a first port 1102, a second port 1104, a third port 1106 and a coupling element 1110 defining or otherwise comprising a coupling cavity, wherein the first port 1102 is connected a first side of the coupling cavity and the second port 1104 and the third port 1108 are connected to a second side of the coupling cavity, the second side opposing the first side. In embodiments disclosed herein, the module 1100 further comprises a fourth port 1108 connected to the first side. The first port 1102 and the fourth port 1108 are for H-plane signals to propagate therethrough and the second port 1104 and the third port 1106 are for E-plane signals to propagate therethrough. The coupling element 1110 is for transforming between H-plane signals of the first port 1102 and the fourth port 1108 and E-plane signals of the second port 1104 and the third port 1106. In embodiments disclosed herein, the module 1100 comprises a symmetry plane 1118 about which the first port 1102, the second port 1104, the third port 1106 and the fourth port 1108 are angled at about 45 degrees relative thereto. The first port 1102 is symmetrical with the fourth port 1108 about the symmetry plane 1118. The second port 1104 is symmetrical with the third port 1106 about the symmetry plane 1118. Referring to FIG. 11, a first axis is shown as the y-axis, a second axis is shown as the z-axis, and a third axis is shown as the x-axis.

In embodiments disclosed herein, the coupling element 1110 comprises one or more coupling sections. In an embodiment disclosed herein, the coupling element 1110 comprises a first coupling section 1112 connected to the first port 1102 and the fourth port 1108, and the a third coupling section 1116 connected to the second port 1104 and the third port 1106, and, optionally, a second coupling section 1114 between the first coupling section 1112 and the third coupling section 1116. In an embodiment disclosed herein, the coupling element 1110 comprises a second coupling section 1114 connected to the first port 1102 and the fourth port 1108, and a third coupling section 1116 connected to the second port 1104 and the third port 1106, and, optionally, a first coupling section 1112 between the second coupling section 1114 and the third coupling section 1116.

Referring to FIG. 12A, in an embodiment disclosed herein, the first coupling section 1112 defines or otherwise comprises a first rectangular-prism cavity 1120 forming part of the coupling cavity. The first cavity 1120 comprises a first side groove 1122 and a second side groove 1124 along a common side of the coupling cavity extending along 45 degrees relative to the x-axis and y-axis. In embodiments disclosed herein, the first side groove 1122 and the second side groove 1124 are symmetrical about the symmetry plane 1118.

Referring to FIG. 12B, in an embodiment disclosed herein, the second coupling section 1114 defines or otherwise comprises a second rectangular-prism cavity 1126 forming part of the coupling cavity. The second cavity 1126 comprises a third side groove 1128 and a fourth side groove 1130 at corners along the common side. In embodiments disclosed herein, the third side groove 1128 and the fourth side groove 1130 are symmetrical about the symmetry plane 1118. The second cavity 1126 further comprises and central groove 1132 symmetrical about the symmetry plane 1118.

Referring to FIG. 12C, in an embodiment disclosed herein, the third coupling section 1116 defines or otherwise comprises a third rectangular-prism cavity 1134 forming part of the coupling cavity. The third cavity 1134 comprises a first obstruction 1136 and a second obstruction 1138 at corners of the common side. In embodiments disclosed herein, the first obstruction 1136 and the second obstruction 1138 are symmetrical about the symmetry plane 1118. In embodiments disclosed herein, the first obstruction 1136 partially overlaps with the first side groove 1122 and/or the third side groove 1128, and the second obstruction 1138 partially overlaps with the second side groove 1124 and/or the fourth side groove 1130. In embodiments disclosed herein, the first obstruction 1136 and the second obstruction 1138 have a double-step profile as illustrated in FIG. 12C, have a rectangular profile 236, 238 as illustrated in FIG. 3C, have a multi-step profile 1136A, 1138A as illustrated in FIG. 13A, have a chamfered corner profile 1136B, 1138B as illustrated in FIG. 13B, have a smooth saw-tooth profile 1136C, 1138C as illustrated in FIG. 13C or have a saw-tooth profile 1136D, 1138D as illustrated in FIG. 13D.

In embodiments disclosed herein, the module 1100 is dimensioned for a particular operating frequency range having an operating center frequency (f₊), wherein λ₊ is the wavelength associated with f₊. Referring to FIG. 12A, the first coupling section 1112 is dimensioned as follows: a₁₊=1.42*λ₊, b₁₊=0.32*λ₊, wₗ₁₊=0.22*λ₊, hₛ₁₊=0.17*λ₊, wₛ₁₊=0.26*λ₊. Referring to FIG. 12B, the second coupling section 1114 is dimensioned as follows: a₂₊=1.42*λ₊, b₂₊=0.32*λ₊, wₗ₂₊=0.34*λ₊, hₛ₂₊=0.16*λ₊, w_{c2+}=0.23*λ₊, h_{c2+}=0.26*λ₊. Referring to FIG. 12C, the third coupling section 1116 is dimensioned as follows: a₃₊=1.2*λ₊, b₃₊=0.62*λ₊, h_{cs3+}=0.12*λ₊, h_{c3+}=0.15*λ₊, wₗ₃₊=0.18*λ₊, w_{cl3+}=0.13*λ₊. Referring to FIG. 11, l₁=0.17*λ₊, l₂=0.17*λ₊, and l₃=0.16*λ₊.

In an embodiment, the module 1100 is dimensioned for an operating frequency range between about 140-160 GHz with a center frequency of 150 GHz. Referring to FIG. 12A, the first coupling section 1112 is dimensioned as follows: a₁₊=2.85 mm, b₁₊=0.65 mm, wₗ₁₊=0.45 mm, hₛ₁₊=0.35 mm, wₛ₁₊=0.52 mm. Referring to FIG. 12B, the second coupling section 1114 is dimensioned as follows: a₂₊=2.85 mm, b₂₊=0.65 mm, wₗ₂₊=0.68 mm, hₛ₂₊=0.32 mm, w_{c2+}=0.46 mm, h_{c2+}=0.52 mm. Referring to FIG. 12C, the third coupling section 1116 is dimensioned as follows: a₃₊=2.4 mm, b₃₊=1.24 mm, h_{cs3+}=0.24 mm, h_{c3+}=0.3 mm, wₗ₃₊=0.36 mm, w_{cl3+}=0.26 mm. Referring to FIG. 11, l₁=0.34 mm, l₂=0.34 mm, and l₃=0.32 mm.

Specific dimensions and dimensions relative to 4 provided herein are example embodiments and are not intended to be limiting. Specifically, the module 1100 described herein operates where dimensions are outside the specific and relative dimensions provided herein.

In embodiments disclosed herein, the module 1100 is a cruciform directional coupler that divides an electromagnetic signal from an open end of the coupler into two open ends of the coupler, for example, from the first port 1102 to the second port 1104 and the third port 1106, while maintaining the fourth port 1108 isolated or combines two electromagnetic signals from two open ends of the coupler to another open end of the coupler, for example, from the second port 1104 and the third port 1106 to the fourth port 1108 while maintaining the first port 1102 isolated. In embodiments disclosed herein, the coupling element 1110 comprises three coupling sections series-arranged along the symmetry plane 1118, two horizontally positioned H-plane ports (the first port 1102 and the fourth port 1108), and two vertically positioned E-plane ports (the second port 1104 and the third port 1106). The H-plane ports support a TE₁₀ mode and the E-plane ports support a TE₀₁ mode. The electric-field component of TE₁₀ mode is orthogonal with that of TE₀₁ mode.

In summary, in operation of an embodiment disclosed herein, when a first H-plane signal propagates through the first port 1102 towards the coupling cavity, a first E-plane signal propagates away from the module 1100 through the second port 1104 and a second E-plane signals propagates away from the module 1100 through the third port 1106, wherein a first phase of the first E-plane signal leads a second phase of the second E-plane signal by 90 degrees, and the fourth port 1108 is isolated from the first H-plane signal, the first E-plane signal and the second E-plane signal. When the first E-plane signal and the second E-plane signal propagate toward the coupling cavity, wherein the first phase leads the second phase by 90 degrees, the first H-plane signal propagates away from the module 1100, and the fourth port 1108 is isolated from the first H-plane signal, the first E-plane signal and the second E-plane signal. When the second H-plane signal propagates through the fourth port 1108 towards the coupling cavity, the first E-plane signal and the second E-plane signals propagate away from the module 1100, wherein the second phase leads the first phase by 90 degrees, and the first port 1102 is isolated from the second H-plane signal, the first E-plane signal and the second E-plane signal. When the first E-plane signal and the second E-plane signal propagate toward the coupling cavity, wherein the second phase leads the first phase by 90 degrees, the second H-plane signal propagates away from the module 1100, and the first port 1102 is isolated from the second H-plane signal, the first E-plane signal and the second E-plane signal.

In embodiments disclosed herein, to achieve broadband matching, the first coupling section 1112, the second coupling section 1114, and the third coupling section 1116 form a stepped impedance transformer. Specifically, referring to FIG. 12A to FIG. 12C, in embodiments disclosed herein, where the widths (a₁₊, a₂₊, a₃₊) of the coupling sections form a multiple-step structure.

In embodiments disclosed herein, the first coupling section 1112 comprises two side grooves symmetrical about the symmetrical plane 1118, each side groove having a height, hₛ₁₊, and a width, wₛ₁₊. The second coupling section 1114 comprises two side grooves symmetrical about the symmetrical plane 1118, each side groove having a height, h_{c2+}, and a width, wₗ₂₊, and one central groove slot having a height, h_{c2+}, and a width, w_{c2+}. The side grooves and central groove in the first and second coupling section 1112, 1114 guide the electromagnetic signal to the third coupling section 1116. In embodiments disclosed herein, a double-step profile of the first obstruction 1136 and the second obstruction 1138 (having dimensions h_{cs3+}, h_{c3+}, wₗ₃₊, and w_{cl3+}) provide polarization rotation. The double-step profile provides a higher degree of control when designing the module 1100 for polarization rotation.

Computer simulation technology can be used to simulate the cruciform waveguide coupler. An example embodiment of the module 1100 is simulated for E-field distributions as shown in FIG. 14. FIG. 14 shows an excited TE₁₀ mode at the horizontally positioned H-plane port (the first port 1102) successfully converted to TE₀₁ mode at two vertically positioned E-plane ports (the second port 1104 and the third port 1106) through the coupling cavity with approximately equal magnitudes. Of note, there is no wave at the isolated port (the fourth port 1108).

FIG. 15 to FIG. 17 illustrate simulated results of the cruciform module 1100, wherein it can be observed that over the frequency range of interest from 140 GHz to 160 GHz, the input port reflection coefficient is better than −20 dB. Both S₂₁ and S₃₁ vary from 3±0.5 dB with isolation between the two output ports greater than 20 dB. The phase difference between the two output ports (the second port 1104 and the third port 1106) is 90 degrees. Further, it is notable that the entire length of the coupler is only 0.5λ, where λ is a wavelength corresponding to the center frequency. The cruciform module 1100 provides an alternative physical structure to the module 200.

In embodiments disclosed herein, the modules 1100 are air-filled hollow waveguide components and in other embodiment disclosed herein, they are filled with a dielectric material. In embodiments disclosed herein, modules 200 are fabricated with conventional CNC machining, EDM process or 3D printing.

In embodiments disclosed herein, the modules comprise more than four ports comprising more than two H-plane ports and more than two E-plane ports. In embodiments disclosed herein.

In other embodiments, the structure of the coupling element can be based on ridge-gap waveguide techniques and/or glide-hole waveguide techniques to provide self-contained 90-degree polarization rotation couplers.

The disclosed directional coupler is not limited to four ports. In fact, the disclosed directional coupler may have more than six (6) open ends, i.e. ports, and several ports may be extended according to specific applications. In addition, the disclosed directional coupler is not limited to 3 dB coupling. Tight-coupling couplers (coupling<10 dB) and loose-coupling couplers (coupling>10 dB) can be achieved.

Those skilled in the art will appreciate that the values of the dimensions and angles described above are examples only and may vary with certain ranges. Such values with certain ranges are sometimes referred in above description using the term “about”. Examples of the ranges for such values may be ±5% in some embodiments, or ±10% in some other embodiments, or ±15% in yet some other embodiments, or ±20% in still some other embodiments, or ±25% in some other embodiments, or ±30% in some other embodiments, or ±35% in yet some other embodiments, or ±40% in some other embodiments, or ±45% in some other embodiments, or ±50% in some other embodiments, or ±55% in some other embodiments, or ±60% in some other embodiments.

Although embodiments have been described above with reference to the accompanying drawings, those of skill in the art will appreciate that variations and modifications may be made without departing from the scope thereof as defined by the appended claims.

1. A module comprising:
a first port for a first H-plane signal to propagate therethrough;
a second port for a first E-plane signal to propagate therethrough;
a third port for a second E-plane signal to propagate therethrough; and
a coupling element for transformation between the first H-plane signal and the first E-plane signal, and for transformation between the first H-plane signal and the second E-plane signal, the coupling element comprising a coupling cavity;
wherein the first port is located on a first side of the coupling cavity;
wherein the second port and the third port are located on a second side of the coupling cavity, the second side opposite the first side;
wherein a third side of the coupling cavity is adjacent the first and second sides as well as proximate to the first and second ports, the third side opposite a fourth side of the coupling cavity;
wherein a first axis extends perpendicularly between the first and second sides;
wherein a second axis extends parallel to the third and fourth sides, the second axis orthogonal to the first axis;
wherein a third axis is orthogonal to the first and second axes;
wherein the second and third ports are opposite with respect to and symmetrical about a symmetry plane parallel to the first and second axes through a center of the coupling cavity;
wherein the coupling element comprises:
a first coupling section comprising a first rectangular-prism cavity forming part of the coupling cavity, the first cavity comprising:
the first side of the coupling cavity, and
a first and a second side groove along the fourth side extending parallel to the first axis, the first and second side grooves being symmetrical about the symmetry plane; and
a second coupling section comprising a second rectangular-prism cavity forming part of the coupling cavity, the second cavity comprising:
the second side of the coupling cavity, and
two obstructions on corners along the fourth side, the obstructions symmetrical about the symmetry plane.

2. The module of claim 1 further comprising a fourth port located on the first side of the coupling cavity for a second H-plane signal to propagate through, wherein the first and fourth ports are opposite with respect to and symmetrical about the symmetry plane,
wherein when the first H-plane signal propagates through the first port towards the coupling cavity, the first E-plane signal and the second E-plane signals propagate away from the module, wherein a first phase of the first E-plane signal leads a second phase of the second E-plane signal by 90 degrees, and the fourth port is isolated from the first H-plane signal, the first E-plane signal and the second E-plane signal;
wherein when the first E-plane signal and the second E-plane signal propagate toward the coupling cavity, wherein the first phase leads the second phase by 90 degrees, the first H-plane signal propagates away from the module, and the fourth port is isolated from the first H-plane signal, the first E-plane signal and the second E-plane signal;
wherein when the second H-plane signal propagates through the fourth port towards the coupling cavity, the first E-plane signal and the second E-plane signals propagate away from the module, wherein the second phase leads the first phase by 90 degrees, and the first port is isolated from the second H-plane signal, the first E-plane signal and the second E-plane signal; and
wherein when the first E-plane signal and the second E-plane signal propagate toward the coupling cavity, wherein the second phase leads the first phase by 90 degrees, the second H-plane signal propagates away from the module, and the first port is isolated from the second H-plane signal, the first E-plane signal and the second E-plane signal.

3. The module of claim 1, wherein each of the obstructions partially overlaps with one of the first and second side grooves.

4. The module of claim 1, wherein the first coupling section further comprises a first central groove along the fourth side extending parallel to the first axis and symmetrical about the symmetry plane.

5. The module of claim 1,
wherein a first long edge of the first cavity forming part of the third side is greater than a second long edge of the second cavity forming part of the third side; and
wherein the first coupling section and the second coupling section are each symmetrical about the symmetry plane.

6. The module of claim 1, wherein the coupling element further comprises a third coupling section comprising a third rectangular-prism cavity forming part of the coupling cavity, the third coupling section between the first and second coupling sections, the third coupling section comprising:
a third and a fourth side groove along the fourth side extending parallel to the first axis, the third and fourth side grooves being symmetrical about the symmetry plane; and
a second central groove along the fourth side extending parallel to the first axis and symmetrical about the symmetry plane.

7. The module of claim 6,
wherein a third long edge of the third cavity forming part of the third side is greater than the second long edge and less than the first long edge; and
wherein the third coupling section is symmetrical about the symmetry plane.

8. The module of claim 1, wherein for a center wavelength of a frequency range,
the length of the first long edge is about 1.45 times the wavelength;
a first short edge of the first coupling section parallel to the third edge, is 0.32 times the wavelength;
the first side groove is 0.24 times the wavelength away from the first short edge;
the first side groove extends 0.14 times the wavelength away from the fourth side;
the first side groove extends 0.2 times the wavelength along the second axis; and
the first coupling section has a depth of 0.15 times the wavelength along the first axis.

9. The module of claim 1, wherein the obstructions are rectangular.

10. The module of claim 9, wherein
the length of the second long edge is 1.14 times the wavelength;
a second short edge of the second coupling section parallel to the third edge, is 0.62 times the wavelength;
each obstruction extends 0.24 times the wavelength along the second axis;
each obstruction extends 0.28 times the wavelength along the third axis; and
the second coupling section has a depth of 0.16 times the wavelength along the first axis.

11. The module of claim 9, wherein each of the obstructions comprises a chamfered corner, and wherein the chamfered corner comprises one of: a double-step profile, a multi-step profile, a saw-tooth profile, or a smooth saw-tooth profile.

12. The module of claim 7, wherein for a center wavelength of a frequency range,
the length of the third long edge is 1.28 times the wavelength;
a third short edge of the third coupling section parallel to the third edge, is 0.35 times the wavelength;
the third side groove is 0.17 times the wavelength away from the third short edge;
the third side groove extends 0.1 times the wavelength away from the fourth side;
the third side groove extends 0.23 times the wavelength along the second axis;
the second central groove extends 0.62 times the wavelength away from the fourth side;
the second central groove extends 0.21 times the wavelength along the second axis; and
the third coupling section has a depth of 0.18 times the wavelength along the first axis.

13. The module of claim 1, wherein the first, second and third ports are angled at 45 degrees relative to the symmetry plane.

14. The module of claim 13 further comprising a fourth port located on the first side of the coupling cavity for a second H-plane signal to propagate through, wherein the first and fourth ports are on opposite sides of and symmetrical about the symmetry plane, the fourth port is angled at 45 degrees relative to the symmetry plane,
wherein when the first H-plane signal propagates through the first port towards the coupling cavity, the first E-plane signal and the second E-plane signals propagate away from the module, wherein a first phase of the first E-plane signal leads a second phase of the second E-plane signal by 90 degrees, and the fourth port is isolated from the first H-plane signal, the first E-plane signal and the second E-plane signal;
wherein when the first E-plane signal and the second E-plane signal propagate toward the coupling cavity, wherein the first phase leads the second phase by 90 degrees, the first H-plane signal propagates away from the module, and the fourth port is isolated from the first H-plane signal, the first E-plane signal and the second E-plane signal;
wherein when the second H-plane signal propagates through the fourth port towards the coupling cavity, the first E-plane signal and the second E-plane signals propagate away from the module, wherein the second phase leads the first phase by 90 degrees, and the first port is isolated from the second H-plane signal, the first E-plane signal and the second E-plane signal; and
wherein when the first E-plane signal and the second E-plane signal propagate toward the coupling cavity, wherein the second phase leads the first phase by 90 degrees, the second H-plane signal propagates away from the module, and the first port is isolated from the second H-plane signal, the first E-plane signal and the second E-plane signal.

15. The module of claim 14, wherein the coupling element further comprises a third coupling section comprising a third rectangular-prism cavity forming part of the coupling cavity, the third coupling section between the first and second coupling sections, the third coupling section comprising:
a third and a fourth side groove at corners of the fourth side and extending parallel to the first axis, the third and fourth side grooves being symmetrical about the symmetry plane; and
a second central groove along the fourth side extending parallel to the first axis and symmetrical about the symmetry plane.

16. The module of claim 15,
wherein a third long edge of the third cavity forming part of the third side is greater than the second long edge and equal to the first long edge; and
wherein the third coupling section is symmetrical about the symmetry plane.

17. The module of claim 14, wherein for a center wavelength of a frequency range,
the length of the first long edge is 1.42 times the wavelength;
a first short edge of the first coupling section parallel to the third edge, is 0.32 times the wavelength;
the first side groove is 0.22 times the wavelength away from the first short edge;
the first side groove extends 0.17 times the wavelength away from the fourth side;
the first side groove extends 0.26 times the wavelength along the second axis; and
the first coupling section has a depth of 0.17 times the wavelength along the first axis.

18. The module of claim 14, wherein the obstructions are rectangular, wherein each of the obstructions comprises a chamfered corner, and wherein the chamfered corner comprises one of a double-step profile, a multi-step profile, a saw-tooth profile, or a smooth saw-tooth profile.

19. The module of claim 18, wherein
the length of the second long edge is 1.2 times the wavelength;
a second short edge of the second coupling section parallel to the third edge, is 0.62 times the wavelength;
each obstruction comprises a first-step adjacent the fourth side extending 0.13 times the wavelength along the second axis and 0.15 times the wavelength along the third axis, and a second-step extending 0.18 times the wavelength along the second axis and 0.12 times the wavelength along the third axis; and
the second coupling section has a depth of 0.16 times the wavelength along the first axis.

20. The module of claim 15, wherein for a center wavelength of a frequency range,
the length of the third long edge is 1.42 times the wavelength;
a third short edge of the third coupling section parallel to the third edge, is 0.32 times the wavelength;
the third side groove extends 0.16 times the wavelength away from the fourth side;
the third side groove extends 0.34 times the wavelength along the second axis;
the second central groove extends 0.26 times the wavelength away from the fourth side;
the second central groove extends 0.23 times the wavelength along the second axis; and
the third coupling section has a depth of 0.17 times the wavelength along the first axis.
